(19) United States
(12) Patent Application Publication
(10) Pub. No.: US 2026/0019337 A1
(43) Pub. Date: Jan. 15, 2026

(54) BANDWIDTH PART SWITCHING FOR NETWORK DEVICES

(71) Applicant: QUALCOMM Incorporated, San Diego, CA (US)

(72) Inventors: Ming YANG, San Diego, CA (US); Kausik RAY CHAUDHURI, San Diego, CA (US); Juan MONTOJO, San Diego, CA (US)

(21) Appl. No.: 19/257,280

(22) Filed: Jul. 1, 2025

Related U.S. Application Data
(60) Provisional application No. 63/669,313, filed on Jul. 10, 2024.

(51) Int. Cl. H04L 41/0896; H04L 41/147; H04L 41/16

(52) U.S. Cl. CPC H04L 41/0896; H04L 41/147; H04L 41/16

(57) ABSTRACT

Methods, systems, and devices for wireless communications are described. In some wireless communication systems, a user equipment (UE) may transmit, to a network entity, a capability message indicating that the UE is capable of performing a bandwidth part (BWP) switching procedure. Based on the receiving the capability message, the network entity may then transmit a configuration message indicated for the UE to perform the BWP switching procedure in response to a bandwidth part switch command that comprises an indication of a respective downlink grant, uplink grant, or both in the respective target bandwidth part. The UE may further transmit a feedback message to accept or reject the BWP switch command that instructs the UE to switch the active BWP of the UE to a target BWP, which is the same BWP or a different BWP than the target BWP indicated by the network entity.

### CROSS REFERENCES

The present application for patent claims benefit of U.S. Provisional Patent Application No. 63/669,313 by YANG et al., entitled “BANDWIDTH PART SWITCHING FOR NETWORK DEVICES,” filed Jul. 10, 2024, assigned to the assignee hereof, and expressly incorporated by reference in its entirety herein.

### FIELD OF TECHNOLOGY

The following relates to wireless communications, including bandwidth part (BWP) switching for network devices.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method by a user equipment (UE) is described. The method may include transmitting, to a network entity, a capability message indicating that the UE is capable of performing a bandwidth part (BWP) switching procedure of an active BWP of the UE to a respective target BWP, receiving, from the network entity and based on the capability message, a configuration message indicating for the UE to perform the BWP switching procedure in response to a BWP switch command that includes an indication of a respective grant in a respective target BWP, receiving, from the network entity and based on the configuration message, a BWP switch command that includes an indication of a grant in a target BWP of a set of multiple BWPs, where the BWP switch command instructs the UE to switch the active BWP of the UE to the target BWP based on the indication of the grant in the target BWP, and transmitting, to the network entity, a feedback message in response to the BWP switch command, where the feedback message indicates whether the UE is to accept the switch to the active BWP of the UE to the target bandwidth part in response to the BWP switch command.

A UE is described. The UE may include one or more memories storing processor executable code, and one or more processors coupled with the one or more memories. The one or more processors may individually or collectively be operable to execute the code to cause the UE to transmit, to a network entity, a capability message indicating that the UE is capable of performing a BWP switching procedure of an active BWP of the UE to a respective target BWP, receive, from the network entity and based on the capability message, a configuration message indicating for the UE to perform the BWP switching procedure in response to a BWP switch command that includes an indication of a respective grant in a respective target BWP, receive, from the network entity and based on the configuration message, a BWP switch command that includes an indication of a grant in a target BWP of a set of multiple BWPs, where the BWP switch command instructs the UE to switch the active BWP of the UE to the target BWP based on the indication of the grant in the target BWP, and transmit, to the network entity, a feedback message in response to the BWP switch command, where the feedback message indicates whether the UE is to accept the switch to the active BWP of the UE to the target bandwidth part in response to the BWP switch command.

Another UE is described. The UE may include means for transmitting, to a network entity, a capability message indicating that the UE is capable of performing a BWP switching procedure of an active BWP of the UE to a respective target BWP, means for receiving, from the network entity and based on the capability message, a configuration message indicating for the UE to perform the BWP switching procedure in response to a BWP switch command that includes an indication of a respective grant in a respective target BWP, means for receiving, from the network entity and based on the configuration message, a BWP switch command that includes an indication of a grant in a target BWP of a set of multiple BWPs, where the BWP switch command instructs the UE to switch the active BWP of the UE to the target BWP based on the indication of the grant in the target BWP, and means for transmitting, to the network entity, a feedback message in response to the BWP switch command, where the feedback message indicates whether the UE is to accept the switch to the active BWP of the UE to the target bandwidth part in response to the BWP switch command.

A non-transitory computer-readable medium storing code is described. The code may include instructions executable by one or more processors to transmit, to a network entity, a capability message indicating that the UE is capable of performing a BWP switching procedure of an active BWP of the UE to a respective target BWP, receive, from the network entity and based on the capability message, a configuration message indicating for the UE to perform the BWP switching procedure in response to a BWP switch command that includes an indication of a respective grant in a respective target BWP, receive, from the network entity and based on the configuration message, a BWP switch command that includes an indication of a grant in a target BWP of a set of multiple BWPs, where the BWP switch command instructs the UE to switch the active BWP of the UE to the target BWP based on the indication of the grant in the target BWP, and transmit, to the network entity, a feedback message in response to the BWP switch command, where the feedback message indicates whether the UE is to accept the switch to the active BWP of the UE to the target bandwidth part in response to the BWP switch command.

In some examples of the method, UEs, and non-transitory computer-readable medium described herein, transmitting the feedback message may include operations, features, means, or instructions for transmitting, to the network entity via the feedback message an indication of an acceptance of the BWP switch command or an indication of a denial of the BWP switch command, where the indication of whether the UE may be to accept the switch the active BWP of the UE to the target BWP in response to the BWP switch command may be based on the indication of the acceptance or the indication of the denial, and where the feedback message includes an indication of a different target BWP.

Some examples of the method, UEs, and non-transitory computer-readable medium described herein may further include operations, features, means, or instructions for generating a prediction of subsequent communication traffic, where the feedback message may be transmitted based on the prediction of the subsequent communication traffic.

In some examples of the method, UEs, and non-transitory computer-readable medium described herein, the prediction of the subsequent communication traffic may be generated via an artificial intelligence or machine learning (AI/ML) model at the UE.

In some examples of the method, UEs, and non-transitory computer-readable medium described herein, transmitting the feedback message may include operations, features, means, or instructions for transmitting, to the network entity via the feedback message, an acknowledgment of the BWP switch command, a negative acknowledgment of the BWP switch command, a suggestion for the UE to perform the BWP switching procedure from the active BWP to a second target BWP of the set of multiple BWPs, or any combination thereof, where the second target BWP may be different from both the active BWP and the target BWP, and where the active BWP, the target BWP, the second target BWP, or any combination thereof may have a same downlink control channel monitoring pattern, a different downlink control channel monitoring pattern, or both.

In some examples of the method, UEs, and non-transitory computer-readable medium described herein, transmitting the feedback message may include operations, features, means, or instructions for transmitting, to the network entity, a negative acknowledgment via the feedback message, where the UE refrains from performing the BWP switching procedure from the active BWP to the target BWP based on the feedback message indicating the negative acknowledgment.

Some examples of the method, UEs, and non-transitory computer-readable medium described herein may further include operations, features, means, or instructions for performing, in response to receiving the BWP switch command, the BWP switching procedure from the active BWP to the target BWP.

Some examples of the method, UEs, and non-transitory computer-readable medium described herein may further include operations, features, means, or instructions for communicating with the network entity in target BWP in response to a performance of the switch from the active BWP to the target BWP based on the indication of the grant in the target BWP indicated via in the BWP switch command.

Some examples of the method, UEs, and non-transitory computer-readable medium described herein may further include operations, features, means, or instructions for receiving, via the BWP switch command, an indication of a target BWP, a quantity of slots for a BWP switching latency corresponding to a performance of the BWP switching procedure, an uplink grant in the target BWP, a downlink grant in the target BWP, or any combination thereof.

Some examples of the method, UEs, and non-transitory computer-readable medium described herein may further include operations, features, means, or instructions for receiving, via the BWP switch command, an indication of a target BWP, a quantity of slots for an uplink grant in the target BWP, a quantity of slots for a downlink grant in the target BWP, or any combination thereof, where the BWP switch command indicates a grant size, a quantity of bits, or both, that match the target BWP.

Some examples of the method, UEs, and non-transitory computer-readable medium described herein may further include operations, features, means, or instructions for receiving, via the BWP switch command, an indication to switch from a first downlink control channel monitoring pattern to a second downlink control channel monitoring pattern within a same BWP or a different BWP based on the BWP switch command including a BWP identifier that may be common or different between the first BWP and the second BWP, where the first downlink control channel monitoring pattern and the second downlink control channel monitoring pattern indicate a dense monitoring pattern or a sparse monitoring pattern.

In some examples of the method, UEs, and non-transitory computer-readable medium described herein, the one or more network conditions include a throughput level satisfying a throughput threshold, a buffer size satisfying a buffer size threshold, a buffer empty latency satisfying a latency threshold, or any combination thereof.

In some examples of the method, UEs, and non-transitory computer-readable medium described herein, the BWP switch command may be received based on one or more network conditions being satisfied.

In some examples of the method, UEs, and non-transitory computer-readable medium described herein, the BWP switch command may be received via a medium access control (MAC)-control element (CE) message.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIGS. 1 and 2 show examples of a wireless communications system that supports including bandwidth part (BWP) switching for network devices in accordance with one or more aspects of the present disclosure.

FIG. 3 shows an example of a process flow that supports BWP switching for network devices in accordance with one or more aspects of the present disclosure.

FIGS. 4 and 5 show block diagrams of devices that support BWP switching for network devices in accordance with one or more aspects of the present disclosure.

FIG. 6 shows a block diagram of a communications manager that supports BWP switching for network devices in accordance with one or more aspects of the present disclosure.

FIG. 7 shows a diagram of a system including a device that supports BWP switching for network devices in accordance with one or more aspects of the present disclosure.

FIG. 8 shows a flowchart illustrating methods that support BWP switching for network devices in accordance with one or more aspects of the present disclosure.

### DETAILED DESCRIPTION

In some wireless communication systems, user equipment (UEs) may switch between bandwidth parts (BWPs) based on network conditions. For example, a network entity may indicate for a UE to switch from a narrower BWP to a wider BWP based on an increase in a buffer size or increase in throughput, or vice versa. To indicate for the UE to switch between BWPs, a network entity may transmit a downlink control information (DCI) message indicating which bandwidth part to which the UE should switch. For example, a network entity may configure a UE with multiple (e.g., four) BWPs where at least one BWP is an active BWP. Thus, the UE may receive a DCI message from a network entity indicating an identifier (ID) of a BWP for the UE to switch to be the active BWP.

In some cases, due to the DCI size being different per BWP, the network entity may add padding data or may truncate the data of the DCI to match a DCI size of a target BWP. In some other cases, a UE may miss a downlink control channel (e.g., a physical downlink control channel (PDCCH)) transmission of the DCI. In such cases, due to a lack of a feedback mechanism for the UE to transmit a positive acknowledgment (ACK) or a negative acknowledgment (NACK) in response to the DCI indication of a BWP switch, the network entity may assume a UE has switched to the indicated BWP. Additionally, or alternatively, the UE may incorrectly interpret a DCI as a BWP switch. In response, the UE may incorrectly or mistakenly perform a BWP switch based on the misinterpretation of the DCI. Thus, in some cases, the wireless communications system may experience a BWP mismatch between the UE and the network entity, which may result in an increase in latency of communications and a decrease in efficiency, effectiveness, and reliability of the wireless communications system. For example, a BWP mismatch may result in a drop or a failure in a connection between a UE and a network entity, among other examples.

To reduce the probability of BWP mismatches and reduce the resource-consumption associated with indicating a BWP switch, the techniques of the present disclosure enable a network entity to transmit a BWP switch command via a control message, such as a medium access control (MAC)-control element (CE) message. For a network entity to indicate a BWP switch command, a UE may transmit a capability message indicating that the UE is capable of performing BWP switching in response to a command, which may be referred to as a BWP switch command, that indicates for the UE to switch an active BWP to a target BWP. Based on the capability message, the network entity may transmit a configuration message to the UE to configure or instruct the UE to be operable to receive one or more BWP switch commands via one or more control messages (e.g., MAC-CE(s)). Once configured, the UE may receive a BWP switch command from a network entity. In such instances, the UE may be capable of providing feedback on the BWP switch command. For example, the UE may transmit a feedback message that includes an ACK indicating that the UE successfully decoded and accepts the BWP switch command, and that the UE will switch to the indicated BWP. In some cases, the feedback message may include a NACK to indicate that the UE is denying to switch to the indicated BWP, or a NACK along with a suggestion of a different BWP to switch to.

In some examples, by having the network entity utilize a control message such as a MAC-CE message rather than a DCI message for transmitting BWP switch commands, BWP switching may be more efficient and reliable. For example, the network entity may refrain from adding or truncating data when transmitting a BWP switch command via a MAC-CE message resulting in a reduction in resource consumption. Further, as the UE may be capable of sending feedback for a BWP switch command that is transmitted via a MAC-CE message, the BWP switching procedure may be more accurate and reliable, thus resulting in a more reliable wireless communications system.

Aspects of the disclosure are initially described in the context of wireless communications systems. Additional aspects of the disclosure are described with reference to a wireless communications system and a process flow. Aspects of the disclosure are further illustrated by and described with reference to apparatus diagrams, system diagrams, and flowcharts that relate to BWP switching for network devices.

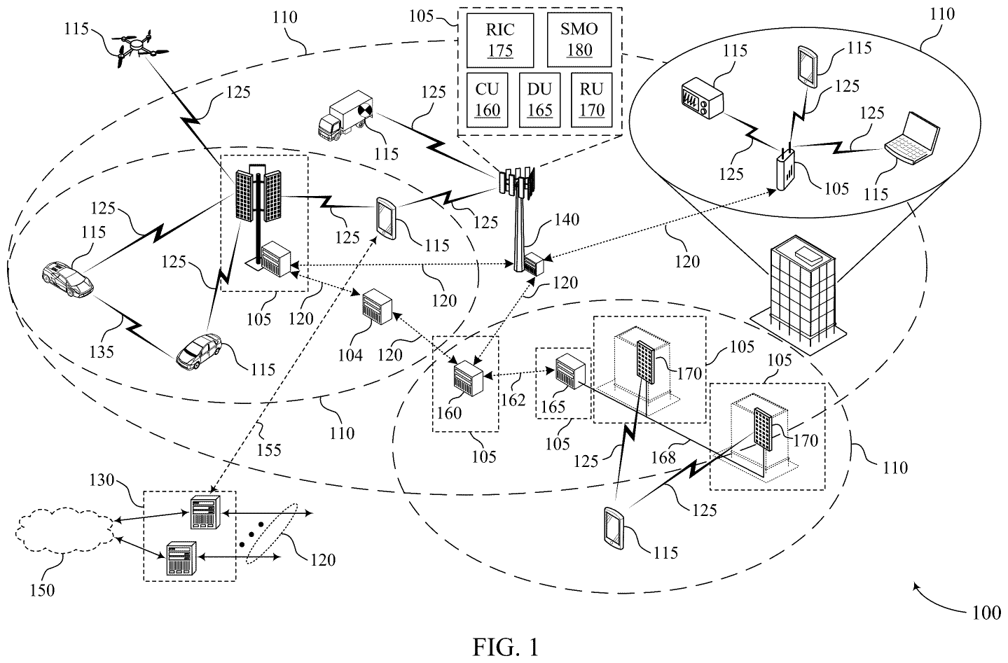

FIG. 1 shows an example of a wireless communications system 100 that supports BWP switching for network devices in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

Certain aspects and techniques as described herein may be implemented, at least in part, using an artificial intelligence (AI) program, such as a program that includes a machine learning (ML) or artificial neural network (ANN) model. An example ML model may include mathematical representations or define computing capabilities for making inferences from input data based on patterns or relationships identified in the input data. As used herein, the term “inferences” can include one or more of decisions, predictions, determinations, or values, which may represent outputs of the ML model. The computing capabilities may be defined in terms of certain parameters of the ML model, such as weights and biases. Weights may indicate relationships between certain input data and certain outputs of the ML model, and biases are offsets which may indicate a starting point for outputs of the ML model. An example ML model operating on input data may start at an initial output based on the biases and then update its output based on a combination of the input data and the weights.

In some aspects, an ML model may be configured to provide computing capabilities for wireless communications. Such an ML model may be configured with weights and biases to perform communication traffic predictions. Thus, during operation of a device, the ML model may receive input data (e.g., historical communication traffic information, network conditions at a network entity 105, channel quality conditions, or any combination thereof) and make inferences (e.g., predictions on the communication traffic at a UE 115) based on the weights and biases.

ML models may be deployed in one or more devices (for example, network entities 105 and UEs 115) and may be configured to enhance various aspects of a wireless communication system. For example, an ML model may be trained to identify patterns or relationships in data corresponding to a network, a device, an air interface, or the like. An ML model may support operational decisions relating to one or more aspects associated with wireless communications devices, networks, or services. For example, an ML model may be utilized for supporting or improving aspects such as signal coding/decoding, network routing, energy conservation, transceiver circuitry controls, frequency synchronization, timing synchronization channel state estimation, channel equalization, channel state feedback, modulation, demodulation, device positioning, beamforming, load balancing, operations and management functions, security, etc.

ML models may be characterized in terms of types of learning that generate specific types of learned models that perform specific types of tasks. For example, different types of machine learning include supervised learning, unsupervised learning, semi-supervised learning, reinforcement learning, etc. ML models may be used to perform different tasks such as classification or regression, where classification refers to determining one or more discrete output values from a set of predefined output values, and regression refers to determining continuous values which are not bounded by predefined output values. Some example ML models configured for performing such tasks include ANNs such as convolutional neural networks (CNNs) and recurrent neural networks (RNNs), transformers, diffusion models, regression analysis models (such as statistical models), large language models (LLMs), decision tree learning (such as predictive models), support vector networks (SVMs), and probabilistic graphical models (such as a Bayesian network), etc.

The description herein illustrates, by way of some examples, how one or more tasks or problems in wireless communications may benefit from the application of one or more ML models to predict communication traffic at a UE 115 from a network entity 105. To facilitate the discussion, an ML model configured using an ANN is used, but it should be understood, that other types of ML models may be used instead of an ANN. Hence, unless expressly recited, subject matter regarding an ML model is not necessarily intended to be limited to an ANN solution. Further, it should be understood that, unless otherwise specifically stated, terms such “AI/ML model,” “ML model,” “trained ML model,” “ANN,” “model,” “algorithm,” or the like are intended to be interchangeable.

In some examples of the wireless communications system 100, UEs 115 may switch between BWPs based on network conditions. To indicate for the UE 115 to switch between BWPs, a network entity 105 may transmit a DCI message indicating which BWP the UE 115 should switch to. For example, a network entity 105 may configure a UE 115 with upwards of four BWPs where at least one BWP is an active BWP. Thus, the UE 115 may receive a DCI message from a network entity 105 indicating an ID of a BWP for the UE to switch to. In some examples, the wireless communications system 100 may experience a BWP mismatch between the UE 115 and the network entity 105. Further, a BWP mismatch may result in an increase in latency of communications and a decrease in efficiency, effectiveness, and reliability of the wireless communications system 100.

To reduce the possibility of BWP mismatches and reduce the resource-consumption associated with indicating a BWP switch, the techniques of the present disclosure may describe a network entity 105 transmitting a BWP switch command via a control message other than a DCI such as via a MAC-CE message. For a network entity 105 to indicate a BWP switch command via a non-DCI control message (e.g., via a MAC-CE), a UE 115 may transmit a capability message indicating that the UE 115 is capable of performing BWP switching in response to a MAC-CE message. Based on the capability message, the network entity 105 may transmit a configuration message to the UE 115 to configure and enable the UE 115 to receive the BWP switch commands. Thus, the UE 115 may then receive a BWP switch command and the UE 115 may be capable of providing feedback on the BWP switch command. For example, the UE 115 may transmit a feedback message that includes an ACK indicating that the UE 115 accepts the BWP switch command and will switch to the indicated BWP, a NACK to indicate that the UE 115 is denying or refusing to switch to the indicated BWP, or a NACK along with a suggestion of a different BWP to switch to.

Therefore, by having the network entity 105 utilize a different type of control message, such as a MAC-CE message, rather than a DCI message for transmitting BWP switch commands, BWP switching may be more efficient and reliable. For example, the network entity 105 may be able to refrain from adding or truncating data when transmitting a BWP switch command via a MAC-CE message resulting in a reduction in resource consumption. Further, since the UE 115 may be capable of sending feedback for a BWP switch command that a network entity 105 transmits via a MAC-CE message, the BWP switching may be relatively more accurate and reliable, thus resulting in the wireless communications system 100 being relatively more efficient and reliable.

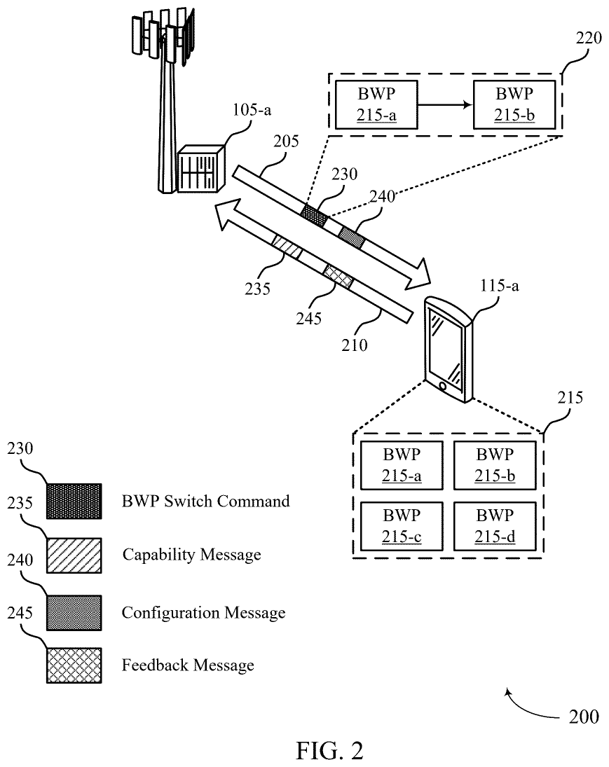

FIG. 2 shows an example of a wireless communications system 200 that supports BWP switching for network devices in accordance with one or more aspects of the present disclosure. In some examples, the wireless communications system 200 may implement or be implemented by the wireless communications system 100. For example, the wireless communications system 200 may include a network entity 105-a and a UE 115-a, which may be examples of devices described herein with reference to FIG. 1. In some examples, the network entity 105-a may communicate with the UE 115-a via a downlink communication link 205 (e.g., a downlink control channel or a physical downlink control channel (PDCCH)) and the UE 115-a may communicate with the network entity 105-a via an uplink communication link 210, which may be examples of a communication link 125 described herein with reference to FIG. 1. For example, the downlink communication link 205 and the uplink communication link 210 may be examples of a Uu link, a sidelink, a backhaul link, a D2D link, or some other type of communication link 125 described herein with reference to FIG. 1.

In some examples, the network entity 105-a may configure the UE 115-a with a set of BWPs 215. For example, the network entity 105-a may configure the UE 115-a with four BWPs 215 (e.g., a BWP 215-a, a BWP 215-b, a BWP 215-c, and a BWP 215-d) and the network entity 105-a may indicate for the UE 115-a to set the BWP 215-a as an active BWP 215. An active BWP 215 may be the BWP 215 that the UE 115-a will operate on for communications with the network entity 105-a. In some examples, the network entity 105-a may also indicate (or define) a default BWP 215 as part of the configuration of the BWPs 215 for the UE 115-a.

In some cases, based on the conditions of the network entity 105-a, the network entity 105-a may indicate for the UE 115-a to perform a BWP switch procedure 220 to switch the active BWP 215 from a first BWP 215 to a second BWP 215. For example, the network entity 105-a may transmit, via the downlink communication link 205, a DCI message to the UE 115-a that includes a BWP 215 switch command instructing the UE 115-a to perform the BWP switch procedure 220 to switch from the BWP 215-a to the BWP 215-b. Due to the DCI size being relatively different for different BWPs 215, a BWP 215 indicator used in the DCI message received in the BWP 215-a may point to the BWP 215-b for data reception where the DCI size of the BWP 215-a is different from the BWP 215-b. However, if the BWP 215 index of the DCI message points to a different BWP 215, it may be relatively difficult for the UE 115-a to interpret the DCI message. Thus, in some examples, the network entity 105-a may pad or truncate bit fields of the DCI message received from a source BWP 215 (e.g., the BWP 215-a). Although, such data padding or data truncating may limit the scheduling abilities of the DCI message during a BWP switch procedure 220. For example, the network entity 105-a may pad the DCI message with dummy data (e.g., non-useful data) for the BWP switch procedure 220 which may waste radio resources. In another example, the network entity 105-a may truncate the data transmitted in the DCI message which may limit the quantity of data transmitted via the DCI message, which can result in an increase in latency of communications.

Further, in some examples, to increase the reliability of the DCI message indicating for the UE 115-a to perform the BWP switch procedure 220, the network entity 105-a may send multiple DCI messages with a common BWP 215 switch command (e.g., each retransmitted DCI message has the same BWP 215 switch command). For example, due to PDCCH blocking, the network entity 105-a may retransmit the DCI message to ensure that the UE 115-a receives a BWP switch command. However, such transmissions may also be a waste of radio resources (e.g., a waste of control channel elements (CCEs)). Moreover, retransmitting a BWP 215 switch command may prevent the network entity 105-a from including other scheduling information within a respective DCI message, thus resulting in an increase in latency of communications and an increase in signaling overhead. Additionally, or alternatively, due to a lack of a feedback mechanism for the UE 115-a to indicate that the UE 115-a has received a BWP 215 switch command indicated in a DCI message, the network entity 105-a may retransmit the BWP 215 switch command unnecessarily. For example, the network entity 105-a may be configured to retransmit the BWP 215 switch command ten times and the UE 115-a may receive the BWP 215 switch command via the first DCI message, thus resulting in a waste of resources in the subsequent nine DCI messages.

Moreover, in some examples of the wireless communications system 100, relatively large scale PDCCH based BWP 215 switch deployments may have active BWP 215 mismatches. In some cases, a BWP 215 mismatch may be a result of the UE 115-a missing a transmission of a DCI message from the network entity 105-a that includes a BWP switch command for the UE 115-a to perform the BWP switch procedure 220. For example, if the UE 115-a is on a cell edge or is far from the network entity 105-a (e.g., there is a relatively large physical distance between the network entity 105-a and the UE 115-a), the UE 115-a may be incapable of receiving the DCI message from the network entity 105-a that includes a BWP switch command. In some other cases, a BWP 215 mismatch may be a result of the UE 115-a incorrectly detecting a BWP 215 switch command within a DCI message or detecting a DCI message that did not originate from the network entity 105-a or the network entity 105-a did not transmit.

In some examples, the network entity 105-a may detect a BWP 215 mismatch based on a counter observation. For example, if an uplink DCI grant message counter is zero after a pre-configured period of time, the network entity 105-a may infer that there is a BWP 215 mismatch between the network entity 105-a and the UE 115-a. In some other examples, the UE 115-a may detect the BWP 215 mismatch. For example, the UE 115-a may be configured via the network entity 105-a to use the BWP 215-b as an active BWP 215 then after a period of time (e.g., 400 ms) the network entity 105-a may switch from the BWP 215-a to the BWP 215-b. Based on the completion of the BWP switch procedure 220 downlink and uplink transmissions may be transmitted for a period of time and may be allocated by one or more DCI message formats. For example, uplink messages may be allocated by a DCI message format (e.g., DCI 0_1) that is allocated for UE 115 specific physical uplink shared channel (PUSCH) transmissions. Further, downlink transmissions may be allocated by a DCI message forma (e.g., DCI 1_1) that is allocated for UE 115 specific physical downlink shared channel (PDSCH) transmissions. Moreover, after the UE 115-a transmits uplink messages and receives downlink messages for a pre-configured period of time, the UE 115-a may report an uplink buffer size to the network entity 105-a via a buffer status report (BSR). For example, the UE 115-a may transmit a BSR to provide the network entity 105-a with information related to the volume of uplink data in the MAC entity.

In such examples, after a period of time, the UE 115-a may stop receiving uplink grants. Thus, the UE 115-a may transmit one or more scheduling requests to the network entity 105-a to request an uplink grant. In some cases, the UE 115-a may transmit a scheduling request maximum (e.g., via sr-TransMax) of 64 scheduling requests to the network entity 105-a without receiving an uplink grant via a DCI message. Therefore, a random access procedure (e.g., RACH procedure) may be initiated due to the UE 115-a having uplink data within a buffer waiting to be transmitted and a lack of an uplink grant. In some cases, while the UE 115-a may be able to re-establish a connection with the network entity 105-a due to a BWP 215 mismatch, the UE 115-a may continue to become disconnected from the network entity 105-a. Therefore, the UE 115-a may declare a radio link failure (RLF) after a maximum quantity of messages being transmitted (e.g., a maximum quantity of MSG1 being triggered) or after a maximum quantity of radio link control (RLC) retransmissions (e.g., 32 RLC retransmissions). Additionally, or alternatively, the network entity 105-a may release the RRC connection with the network entity 105-a before the UE 115-a reaches or attempts the maximum quantity of scheduling requests (e.g., sr-TransMax: 64). Moreover, frequent RLFs may result in an increase in latency in the wireless communications system 200 and may reduce the efficiency, reliability, and accuracy of communications within the wireless communications system 200.

In some cases, to prevent RLF, the network entity 105-a may configure the UE 115-a with a BWP 215 out-of-service (OOS) handling procedure. For example, after the UE 115-a performs the BWP switch procedure 220 to switch the active BWP 215 of the UE 115-a to the BWP 215-b, the UE 115-a may transmit a scheduling request to the network entity 105-a to receive a grant on the BWP 215-b. In some cases, the UE 115-a may wait for a period of time for the scheduling grant and after expiration of a set amount of time, the UE 115-a may automatically switch the active BWP 215 back to the previously active BWP (e.g., the BWP 215-a). In some other cases, the UE 115-a may wait for a set amount of time and then send a retransmission, and then after a set quantity of retransmissions without a scheduling grant being received, the UE 115-a may switch back the BWP 215-a. While switching back to the previously active BWP 215 may be relatively inefficient in terms of time and resource consumption, such time and resource consumption may be better than declaring a RLF due to a BWP mismatch. Further, BWP mismatches between the UE 115-a and the network entity 105-a may also degrade the throughput of communications and a quality of experience (QoE) in the wireless communications system 200.

Thus, in accordance with the techniques of the present disclosure, to prevent a decrease in throughput and QoE and an increase in latency and unreliability in the wireless communications system 200, the network entity 105-a may transmit a BWP switch command 230. In some examples, the BWP switch command 230 may be transmit via a MAC-CE message instead of via the DCI message to reduce the signaling overhead and latency associated with transmitting the BWP switch command 230. Additionally, or alternatively, the BWP switch command 230 may indicate for the UE 115-a to switch from a first downlink control channel monitoring pattern (e.g., a first PDCCH monitoring pattern) to a second downlink control channel monitoring pattern (e.g., a second PDCCH monitoring pattern) that are within the same BWP 215 or different BWPs 215. For example, the BWP switch command 230 (e.g., a BWP switch command 230 within a MAC-CE message) may indicate for the UE 115-a to switch from a dense PDCCH monitoring pattern to a sparse PDCCH monitoring pattern, or vice versa.

In some cases, the UE 115-a may first transmit a capability message 235 indicating that the UE 115-a is capable of performing the BWP switch procedure 220 to switch an active BWP to a respective target BWP. Based on the capability message 235, the network entity 105-a may then, via a configuration message 240, to enable and configure the UE 115-a to perform the BWP switch procedure 220 in response to a BWP switch command 230. In some examples, the configuration message 240 may be a reconfiguration message (e.g., an RRC reconfiguration) that instructs the UE 115-a on how to perform the BWP switch procedure 220. Therefore, in some examples, based on the network entity 105-a satisfying one or more network conditions, the network entity 105-a may transmit the BWP switch command 230 that includes an indication of a grant (e.g., an uplink grant, a downlink grant, or a combination thereof) in a target BWP (e.g., the BWP 215-b) of a set of BWPs. The BWP switch command 230 may instruct the UE 115-a to perform the BWP switch procedure 220 to switch from the BWP 215-a to the BWP 215-b. The one or more network conditions may include a throughput level of the network entity 105-a satisfying a throughput threshold, a buffer size satisfying a buffer size threshold, a buffer empty latency satisfying a latency threshold, or any combination thereof.

For example, if UE 115-a has a relatively large BWP 215 as an active BWP 215 and the network entity 105-a detects or determines that the throughput is relatively low and a transmission buffer is relatively low, the network entity 105-a may transmit the BWP switch command 230 to the UE 115-a to switch to a relatively smaller BWP 215. In another example, if UE 115-a has a relatively small BWP 215 as an active BWP 215 and the throughput level, the buffer size, the buffer empty latency, or any combination thereof are relatively high, the network entity 105-a may transmit the BWP switch command 230 to have the UE 115-a switch to a relatively larger BWP 215. Thus, in some cases, the network entity 105-a may have lower and upper thresholds for the network conditions. Therefore, if a network condition satisfies an upper threshold the BWP switch command 230 may indicate for the UE 115-a to switch to a larger active BWP 215 and if a network condition satisfies a lower threshold the BWP switch command 230 may indicate for the UE 115-a to switch to a smaller active BWP 215. For example, if the throughput and buffer size of the network entity 105-a is relatively low, the network entity 105-a and the UE 115-a may be able to communicate effectively and reliably using a lower active BWP 215, thus resulting in a decrease in resource consumption. Thus, if the communication effectiveness and accuracy between the network entity 105-a and the UE 115-a starts to degrade due to high throughput and a relatively large buffer size, having the UE 115-a switch to a higher active BWP 215 may increase the effectiveness, accuracy, and reliability of the communications in the wireless communications system 200.

In some examples, if the throughput at the network entity 105-a, the buffer size, the buffer empty latency, or any combination thereof, are relatively high or are increasing the network entity 105-a may transmit the BWP switch command 230 for a BWP switch procedure 220. For example, the UE 115-a may be operating on the BWP 215-a that is a small BWP and due to the network conditions of the network entity 105-a (e.g., the throughput, buffer size, buffer empty latency, or any combination thereof), the network entity 105-a may indicate for the UE 115-a to switch to the BWP 215-b that is a relatively larger BWP via a BWP switch command 230. Further, the network entity 105-a may transmit the BWP switch command 230 based on a throughput level satisfying a throughput threshold, a buffer size satisfying a buffer size threshold, a buffer empty latency satisfying a latency threshold, or any combination thereof. In some cases, the BWP switch command 230 may indicate a target BWP 215, a quantity of slots for a BWP 215 switch latency that corresponds to a performance of the BWP switch procedure 220, an uplink grant in the target BWP 215, a downlink grant in the target BWP 215, or any combination thereof. Therefore, due to the indications within the BWP switch command 230, the UE 115-a may be capable of refraining from truncating or padding data to match the DCI size of the target BWP 215. Thus, the techniques of the present disclosure may result in a decrease in unnecessary resource consumption which may in turn result in a decrease in communication latency and an increase in communication efficiency and reliability.

Additionally, or alternatively, due to the network entity 105-a transmitting the BWP switch command 230, the UE 115-a may be capable of transmitting a feedback message 245. In the feedback message 245, the UE 115-a may be capable of accepting or rejecting the BWP 215 switch command based on one or more communication traffic predictions. For example, the UE 115-a may use an AI/ML model, as described with reference to FIG. 1, to predict subsequent communication traffic from the network entity 105-a on the downlink communication link 205. Thus, if the UE 115-a predicts a relatively large volume of incoming communication traffic, the UE 115-a may reject a BWP switch command 230 that requests the UE 115-a to switch from a large BWP 215 to a small BWP 215. Therefore, the UE 115-a may be capable of reducing the latency of communications that the UE 115-a may cause by performing the BWP switch procedure 220 by rejecting a BWP switch command 230 when the UE 115-a predicts an increase in communication traffic.

To accept or reject a BWP switch command 230 (e.g., a BWP switch command 230 within a MAC-CE message), the UE 115-a may transmit an ACK or a NACK via the feedback message 245. For example, when accepting the BWP 215 switch command, the UE 115-a may transmit an ACK via the feedback message 245 to indicate to the network entity 105-a that the UE 115-a has received the BWP switch command 230 and will perform an indicated BWP switch procedure 220. In some examples, when rejecting the BWP switch command 230, the UE 115-a may transmit a NACK via the feedback message 245. For example, the UE 115-a may predict (e.g., via an AI/ML model stored locally on the UE 115-a or on a cloud-based service) that there will be an increase in communication traffic in the near future and may transmit the NACK via the feedback message 245 to the network entity 105-a. Thus, when the UE 115-a transmits the NACK via the feedback message 245 to the network entity 105-a, the UE 115-a may refrain from performing the BWP switch procedure 220.

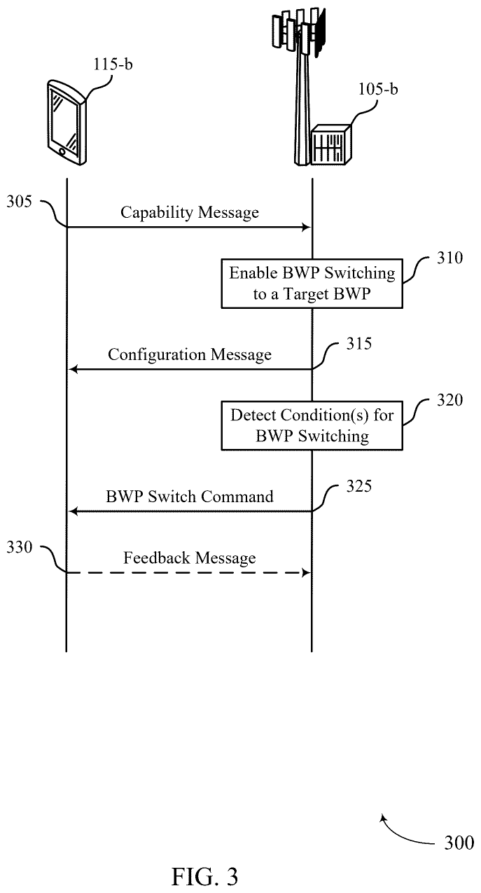

In some examples, when the UE 115-a transmits the NACK via the feedback message 245 the UE 115-a may also include a BWP 215 switch suggestion. For example, the network entity 105-a may transmit a BWP switch command 230 indicating for the UE 115-a to perform a BWP switch procedure 220 from the BWP 215-a to the BWP 215-b (e.g., from a first BWP 215 to a second BWP 215). In response, the UE 115-a may transmit a NACK via the feedback message 245 rejecting the BWP switch command 230 and may instead recommend performing the BWP switch procedure 220 to switch from the BWP 215-a to the BWP 215-c (e.g., a third BWP 215). Based on receiving the feedback message 245, the network entity 105-a may accept or reject the suggestion from the UE 115-a by transmitting a second BWP switch command 230. In some cases, the network entity 105-a may configure the UE 115-a to automatically accept a second BWP switch command 230. In some other cases, the UE 115-a may transmit a feedback message 245 that can either accept or reject the second BWP switch command 230. Thus, the network entity 105-a and the UE 115-a may communicate back and forth until agreeing on a BWP switch procedure 220 for the UE 115-a to perform. Thus, the capability for the UE 115-a to transmit a feedback message 245 in response to a BWP switch command 230 from the network entity 105-a may result in an increase in effectiveness and reliability and a decrease in latency for the wireless communications system 200. Further descriptions of the techniques of the present disclosure enabling the network entity 105-a to transmit the BWP switch command 230 (e.g., a BWP switch command 230 within a MAC-CE message) and enabling the UE 115-a to transmit a feedback message 245 in response may be described elsewhere herein, such as with reference to FIG. 3.

FIG. 3 shows an example of a process flow 300 that supports BWP switching for network devices in accordance with one or more aspects of the present disclosure. In some examples, the process flow 300 may implement or be implemented by the wireless communications system 100, the wireless communications system 200, or both. For example, the process flow 300 may include a UE 115-b and a network entity 105-b, which may be examples of devices described herein with reference to FIGS. 1 and 2.

In the following description of the process flow 300, the operations between the UE 115-b and the network entity 105-b may be performed in different orders or at different times. Some operations may also be left out of the process flow 300, or other operations may be added. Although the UE 115-b and the network entity 105-b are shown performing the operations of the process flow 300, some aspects of some operations may also be performed by one or more other wireless devices.

At 305, a UE 115-b may transmit, to a network entity 105-b, a capability message indicating that the UE 115-b is capable of performing a BWP switching procedure of an active BWP of the UE 115-b to a respective target BWP. In some examples, the BWP switching procedure may be based on a MAC-CE message. Then, at 310, the network entity 105-b may enable the BWP switching for network devices. At 315, the UE 115-b may then receive, from the network entity 105-b and based on the capability message, a configuration message indicating for the UE 115-b to perform the BWP switching procedure in response to a BWP switch command that includes an indication of a respective grant in a respective target BWP. In some cases, the BWP switching procedure according to the MAC-CE message. Moreover, at 320, the network entity 105-b may detect one or more network conditions being satisfied. Thus, based on the one or more network conditions being satisfied trigger the network entity 105-b may transmit a BWP switch command (e.g., a BWP switch command via a MAC-CE).

At 325, the UE 115-b may receive, from the network entity 105-b and based on the configuration message, a BWP switch command (e.g., a BWP switch command via a MAC-CE) that includes an indication of a grant in a target BWP of a set of BWPs. The BWP switch command may instruct the UE 115-b to switch an active BWP of the UE 115-b to a target BWP based on the indication of the grant in the target BWP. In some examples, the UE 115-b may receive, via the BWP switch command, an indication of the target BWP, a quantity of slots for a BWP switching latency, an uplink grant in the target BWP, a downlink grant in the target BWP, or any combination thereof. In some other examples, the UE 115-b may receive, via the BWP switch command, an indication of a target BWP, a quantity of slots for an uplink grant in the target BWP, a quantity of slots for a downlink grant in the target BWP, or any combination thereof, where the BWP switch command indicates a grant size, a quantity of bits, or both, for with target BWP. Additionally, or alternatively, the UE 115-b may receive, via the BWP switch command, an indication to switch from a first downlink control channel monitoring pattern to a second downlink control channel monitoring pattern within a same BWP or a different BWP based on the BWP switch command including a BWP identifier that is common or different between the active BWP and the target BWP. The first downlink control channel monitoring pattern and the second downlink control channel monitoring pattern may indicate a dense monitoring pattern or a sparse monitoring pattern. In some cases, the BWP switch command may be received based on the one or more network conditions being satisfied. For example, the one or more network conditions may include a throughput level satisfying a throughput threshold, a buffer size satisfying a buffer size threshold, a buffer empty latency satisfying a latency threshold, or any combination thereof.

At 330, the UE 115-b may transmit, to the network entity 105-b, a feedback message in response to the BWP switch command. The feedback message may indicate whether the UE is to accept the switch to the active BWP of the UE 115-b to the target BWP in response to the BWP switch command. The feedback message may indicate an acceptance of the BWP switch command or a denial of the BWP switch command. In some examples, the UE 115-b may generate (e.g., via an AI/ML model) a prediction of subsequent communication traffic, and the feedback message may be transmitted based on the prediction of the subsequent communication traffic. In some other examples, the UE 115-b may transmit, to the network entity 105-b via the feedback message, an acknowledgment of the BWP switch command, a negative acknowledgment of the BWP switch command, a suggestion for the UE 115-b to perform the BWP switching procedure from the active BWP to a second target BWP that is different from both the active BWP and the target BWP, or any combination thereof. The active BWP, the target BWP, the second target BWP, or any combination thereof may have a same downlink control channel monitoring pattern or a different downlink control channel monitoring pattern. Additionally, or alternatively, the UE 115-b may transmit, to the network entity 105-b, a negative acknowledgment via the feedback message, and the UE 115-b may refrain from performing the BWP switching procedure from the active BWP to the target BWP based on the feedback message indicating the negative acknowledgment. Thus, in response to receiving the BWP switch command, the UE 115-b may perform the BWP switching procedure from the active BWP to the target BWP. Moreover, the UE 115-b may wait to perform the BWP switching procedure until after transmitting the feedback message.

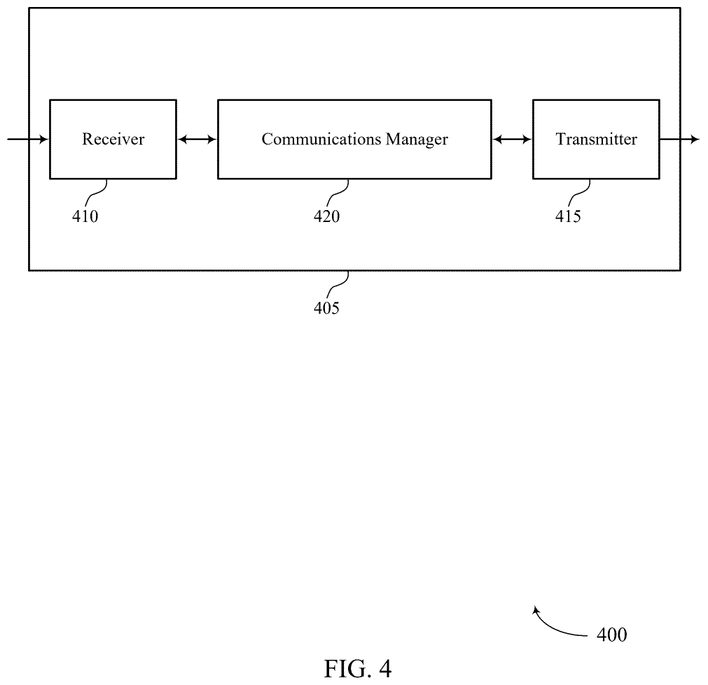

FIG. 4 shows a block diagram 400 of a device 405 that supports BWP switching for network devices in accordance with one or more aspects of the present disclosure. The device 405 may be an example of aspects of a UE 115 as described herein. The device 405 may include a receiver 410, a transmitter 415, and a communications manager 420. The device 405, or one or more components of the device 405 (e.g., the receiver 410, the transmitter 415, the communications manager 420), may include at least one processor, which may be coupled with at least one memory, to, individually or collectively, support or enable the described techniques. Each of these components may be in communication with one another (e.g., via one or more buses).

The receiver 410 may provide a means for receiving information such as packets, user data, control information, or any combination thereof associated with various information channels (e.g., control channels, data channels, information channels related to BWP switching for network devices). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to BWP switching for network devices). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations or components thereof may be examples of means for performing various aspects of BWP switching for network devices as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software or firmware) executed by at least one processor (e.g., referred to as a processor-executable code). If implemented in code executed by at least one processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communications in accordance with examples as disclosed herein. For example, the communications manager 420 is capable of, configured to, or operable to support a means for transmitting, to a network entity, a capability message indicating that the UE is capable of performing a bandwidth part switching procedure of an active bandwidth part of the UE to a respective target bandwidth part. The communications manager 420 is capable of, configured to, or operable to support a means for receiving, from the network entity and based on the capability message, a configuration message indicating for the UE to perform the bandwidth part switching procedure in response to a bandwidth part switch command that includes an indication of a respective grant in a respective target bandwidth part. The communications manager 420 is capable of, configured to, or operable to support a means for receiving, from the network entity and based on the configuration message, a bandwidth part switch command that includes an indication of a grant in a target bandwidth part of a set of multiple of bandwidth parts, where the bandwidth part switch command instructs the UE to switch the active bandwidth part of the UE to the target bandwidth part based part on the indication of the grant in the target bandwidth part. The communications manager 420 is capable of, configured to, or operable to support a means for transmitting, to the network entity, a feedback message in response to the bandwidth part switch command, where the feedback message indicates whether the UE is to accept the switch to the active bandwidth part of the UE to the target bandwidth part in response to the bandwidth part switch command.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques a UE to receive a BWP switch command (e.g., via a MAC-CE) that indicates a grant in a target BWP to support reduced processing, reduced power consumption, and more efficient utilization of communication resources.

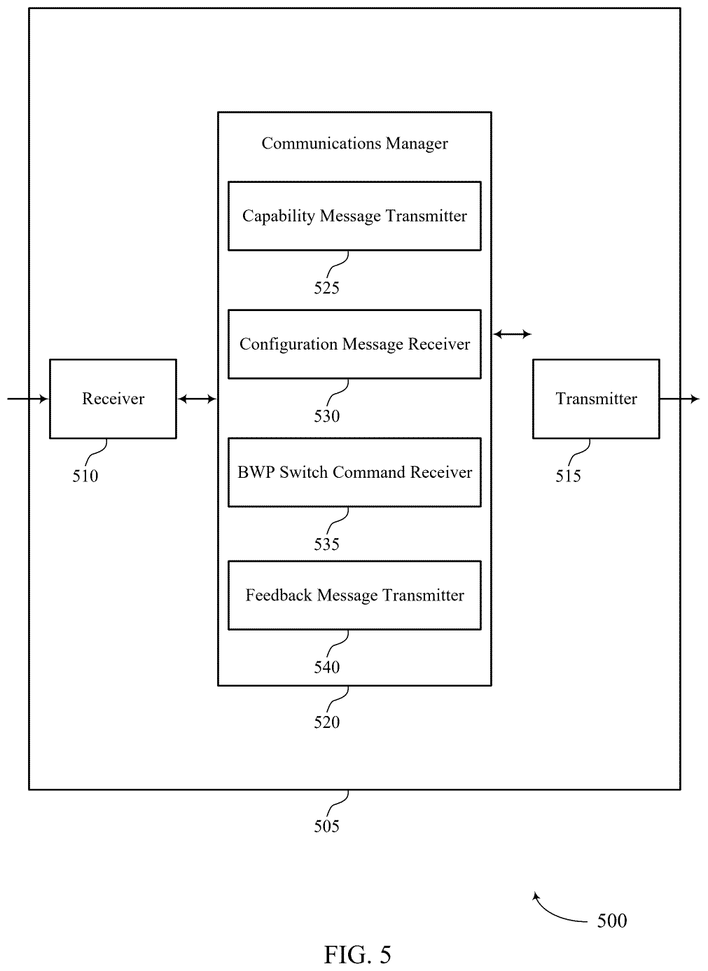

FIG. 5 shows a block diagram 500 of a device 505 that supports BWP switching for network devices in accordance with one or more aspects of the present disclosure. The device 505 may be an example of aspects of a device 405 or a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to support the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to BWP switching for network devices). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to BWP switching for network devices). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of BWP switching for network devices as described herein. For example, the communications manager 520 may include a capability message transmitter 525, a configuration message receiver 530, a BWP switch command receiver 535, a feedback message transmitter 540, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. The capability message transmitter 525 is capable of, configured to, or operable to support a means for transmitting, to a network entity, a capability message indicating that the UE is capable of performing a bandwidth part switching procedure of an active bandwidth part of the UE to a respective target bandwidth part. The configuration message receiver 530 is capable of, configured to, or operable to support a means for receiving, from the network entity and based on the capability message, a configuration message indicating for the UE to perform the bandwidth part switching procedure in response to a bandwidth part switch command that includes an indication of a respective grant in a respective target bandwidth part. The BWP switch command receiver 535 is capable of, configured to, or operable to support a means for receiving, from the network entity and based on the configuration message, a bandwidth part switch command that includes an indication of a grant in a target bandwidth part of a set of multiple of bandwidth parts, where the bandwidth part switch command instructs the UE to switch the active bandwidth part of the UE to the target bandwidth part based on the indication of the grant in the target bandwidth part. The feedback message transmitter 540 is capable of, configured to, or operable to support a means for transmitting, to the network entity, a feedback message in response to the bandwidth part switch command, where the feedback message indicates whether the UE is to accept the switch to the active bandwidth part of the UE to the target bandwidth part in response to the bandwidth part switch command.

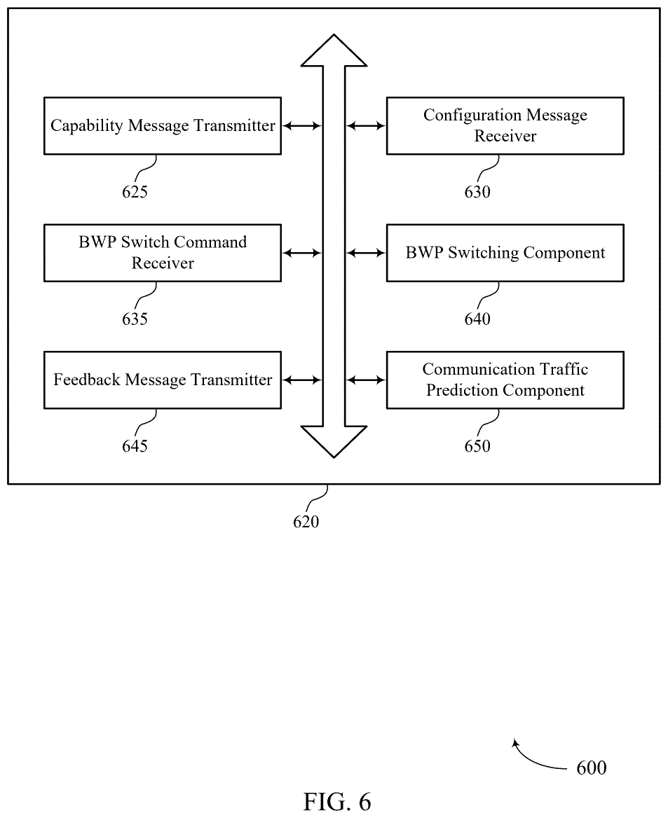

FIG. 6 shows a block diagram 600 of a communications manager 620 that supports BWP switching for network devices in accordance with one or more aspects of the present disclosure. The communications manager 620 may be an example of aspects of a communications manager 420, a communications manager 520, or both, as described herein. The communications manager 620, or various components thereof, may be an example of means for performing various aspects of BWP switching for network devices as described herein. For example, the communications manager 620 may include a capability message transmitter 625, a configuration message receiver 630, a BWP switch command receiver 635, a BWP switching component 640, a feedback message transmitter 645, a communication traffic prediction component 650, or any combination thereof. Each of these components, or components or subcomponents thereof (e.g., one or more processors, one or more memories), may communicate, directly or indirectly, with one another (e.g., via one or more buses).

The communications manager 620 may support wireless communications in accordance with examples as disclosed herein. The capability message transmitter 625 is capable of, configured to, or operable to support a means for transmitting, to a network entity, a capability message indicating that the UE is capable of performing a bandwidth part switching procedure of an active bandwidth part of the UE to a respective target bandwidth part. The configuration message receiver 630 is capable of, configured to, or operable to support a means for receiving, from the network entity and based on the capability message, a configuration message indicating for the UE to perform the bandwidth part switching procedure in response to a bandwidth part switch command that includes an indication of a respective grant in a respective target bandwidth part. The BWP switch command receiver 635 is capable of, configured to, or operable to support a means for receiving, from the network entity and based on the configuration message, a bandwidth part switch command that includes an indication of a grant in a target bandwidth part of a set of multiple bandwidth parts, where the bandwidth part switch command instructs the UE to switch the active bandwidth part of the UE to the target bandwidth part based on the indication of the grant in the target bandwidth part.

In some examples, the BWP switching component 640 is capable of, configured to, or operable to support a means for performing, in response to receiving the bandwidth part switch command, the bandwidth part switching procedure from the active bandwidth part to the target bandwidth part.

In some examples, the BWP switch command receiver 635 is capable of, configured to, or operable to support a means for receiving, via the bandwidth part switch command, an indication of the target bandwidth part, a quantity of slots for a bandwidth part switching latency, an uplink grant in the target bandwidth part, a downlink grant in the target bandwidth part, or any combination thereof.

In some examples, the BWP switch command receiver 635 is capable of, configured to, or operable to support a means for receiving, via the bandwidth part switch command, an indication of a target bandwidth part, a quantity of slots for an uplink grant in the target bandwidth part, a quantity of slots for a downlink grant in the target bandwidth part, or any combination thereof, where the bandwidth part switch command indicates a grant size, a quantity of bits, or both, matching with the target bandwidth part.

In some examples, the BWP switch command receiver 635 is capable of, configured to, or operable to support a means for receiving, via the bandwidth part switch command, an indication to switch from a first downlink control channel monitoring pattern to a second downlink control channel monitoring pattern within a same bandwidth part or a different bandwidth part based on the bandwidth part switch command including a bandwidth part identifier that is common or different between the first bandwidth part and the second bandwidth part, where the first downlink control channel monitoring pattern and the second downlink control channel monitoring pattern indicate a dense monitoring pattern or a sparse monitoring pattern.

In some examples, the feedback message transmitter 645 is capable of, configured to, or operable to support a means for transmitting, to the network entity, a feedback message in response to the bandwidth part switch command, where the feedback message indicates whether the UE is to accept the switch to the active bandwidth part of the UE to the target bandwidth part in response to the bandwidth part switch command.

In some examples, to support transmitting the feedback message, the feedback message transmitter 645 is capable of, configured to, or operable to support a means for transmitting, to the network entity via the feedback message wan indication of an acceptance of the bandwidth part switch command or a denial of the bandwidth part switch command, where the indication of whether the UE is to accept the switch the active bandwidth part of the UE to the target bandwidth part in response to the bandwidth part switch command is based on the indication of the acceptance or the indication of the denial, and where the feedback message comprises an indication of a different target bandwidth part.

In some examples, the communication traffic prediction component 650 is capable of, configured to, or operable to support a means for generating a prediction of subsequent communication traffic, where the feedback message is transmitted based on the prediction of the subsequent communication traffic. In some examples, the prediction of the subsequent communication traffic is generated via an AI/ML model at the UE.

In some examples, to support transmitting the feedback message, the feedback message transmitter 645 is capable of, configured to, or operable to support a means for transmitting, to the network entity via the feedback message, an acknowledgment of the bandwidth part switch command, a negative acknowledgment of the bandwidth part switch command, a suggestion for the UE to perform the bandwidth part switching procedure from the active bandwidth part to a second target bandwidth part of the plurality of bandwidth parts, or any combination thereof, wherein the second target bandwidth part is different from both the active bandwidth part and the target bandwidth part, and wherein the active bandwidth part, the target bandwidth part, the second target bandwidth part, or any combination thereof have a same downlink control channel monitoring pattern, a different downlink control channel monitoring pattern, or both.

In some examples, to support transmitting the feedback message, the feedback message transmitter 645 is capable of, configured to, or operable to support a means for transmitting, to the network entity, a negative acknowledgment via the feedback message, where the UE refrains from performing the bandwidth part switching procedure from the active bandwidth part to the target bandwidth part based on the feedback message indicating the negative acknowledgment.

In some examples, the bandwidth part switch command is received based on one or more network conditions being satisfied.

In some examples, the one or more network conditions include a throughput level satisfying a throughput threshold, a buffer size satisfying a buffer size threshold, a buffer empty latency satisfying a latency threshold, or any combination thereof.

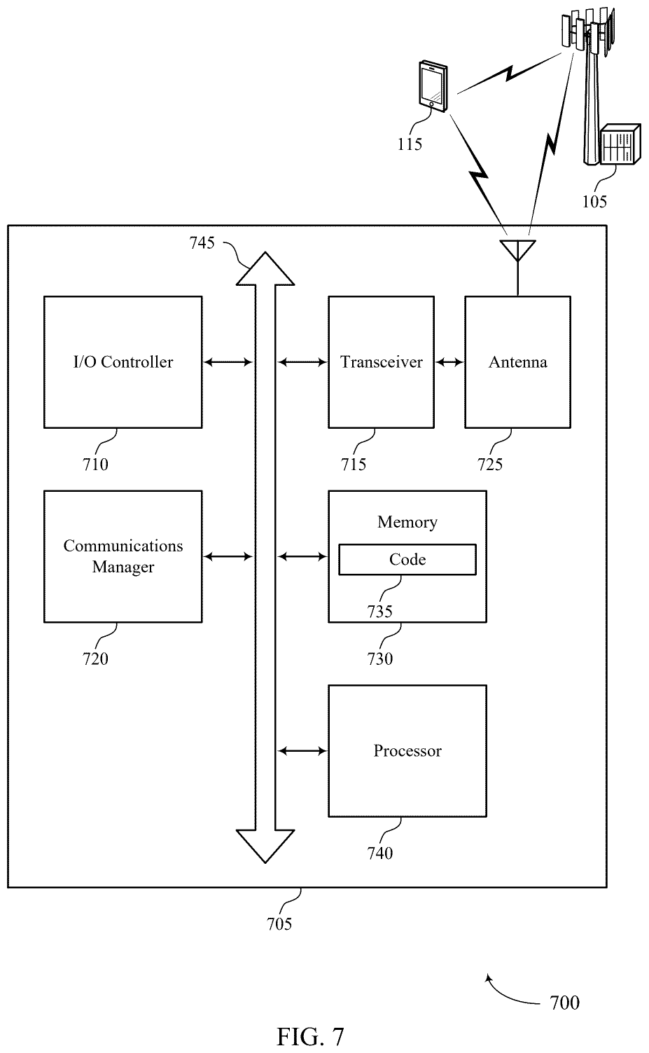

FIG. 7 shows a diagram of a system 700 including a device 705 that supports BWP switching for network devices in accordance with one or more aspects of the present disclosure. The device 705 may be an example of or include components of a device 405, a device 505, or a UE 115 as described herein. The device 705 may communicate (e.g., wirelessly) with one or more other devices (e.g., network entities 105, UEs 115, or a combination thereof). The device 705 may include components for bi-directional voice and data communications including components for transmitting and receiving communications, such as a communications manager 720, an input/output (I/O) controller, such as an I/O controller 710, a transceiver 715, one or more antennas 725, at least one memory 730, code 735, and at least one processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of one or more processors, such as the at least one processor 740. In some cases, a user may interact with the device 705 via the I/O controller 710 or via hardware components controlled by the I/O controller 710.

In some cases, the device 705 may include a single antenna. However, in some other cases, the device 705 may have more than one antenna, which may be capable of concurrently transmitting or receiving multiple wireless transmissions. The transceiver 715 may communicate bi-directionally via the one or more antennas 725 using wired or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The at least one memory 730 may include random access memory (RAM) and read-only memory (ROM). The at least one memory 730 may store computer-readable, computer-executable, or processor-executable code, such as the code 735. The code 735 may include instructions that, when executed by the at least one processor 740, cause the device 705 to perform various functions described herein. The code 735 may be stored in a non-transitory computer-readable medium such as system memory or another type of memory. In some cases, the code 735 may not be directly executable by the at least one processor 740 but may cause a computer (e.g., when compiled and executed) to perform functions described herein. In some cases, the at least one memory 730 may include, among other things, a basic I/O system (BIOS) which may control basic hardware or software operation such as the interaction with peripheral components or devices.

The at least one processor 740 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 740 may be configured to operate a memory array using a memory controller. In some other cases, a memory controller may be integrated into the at least one processor 740. The at least one processor 740 may be configured to execute computer-readable instructions stored in a memory (e.g., the at least one memory 730) to cause the device 705 to perform various functions (e.g., functions or tasks supporting BWP switching for network devices). For example, the device 705 or a component of the device 705 may include at least one processor 740 and at least one memory 730 coupled with or to the at least one processor 740, the at least one processor 740 and the at least one memory 730 configured to perform various functions described herein.

In some examples, the at least one processor 740 may include multiple processors and the at least one memory 730 may include multiple memories. One or more of the multiple processors may be coupled with one or more of the multiple memories, which may, individually or collectively, be configured to perform various functions described herein. In some examples, the at least one processor 740 may be a component of a processing system, which may refer to a system (such as a series) of machines, circuitry (including, for example, one or both of processor circuitry (which may include the at least one processor 740) and memory circuitry (which may include the at least one memory 730)), or components, that receives or obtains inputs and processes the inputs to produce, generate, or obtain a set of outputs. The processing system may be configured to perform one or more of the functions described herein. For example, the at least one processor 740 or a processing system including the at least one processor 740 may be configured to, configurable to, or operable to cause the device 705 to perform one or more of the functions described herein. Further, as described herein, being “configured to,” being “configurable to,” and being “operable to” may be used interchangeably and may be associated with a capability, when executing code 735 (e.g., processor-executable code) stored in the at least one memory 730 or otherwise, to perform one or more of the functions described herein.

The communications manager 720 may support wireless communications in accordance with examples as disclosed herein. For example, the communications manager 720 is capable of, configured to, or operable to support a means for transmitting, to a network entity, a capability message indicating that the UE is capable of performing a bandwidth part switching procedure of an active bandwidth part of the UE to a respective target bandwidth part. The communications manager 720 is capable of, configured to, or operable to support a means for receiving, from the network entity and based on the capability message, in response to a bandwidth part switch command that includes an indication of a respective grant in a respective target bandwidth part. The communications manager 720 is capable of, configured to, or operable to support a means for receiving, from the network entity and based on the configuration message, the bandwidth part switch command including a bandwidth part switch command, where the bandwidth part switch command instructs the UE to switch an active bandwidth part of the UE from a first bandwidth part to a second bandwidth part. The communications manager 720 is capable of, configured to, or operable to support a means for transmitting, to the network entity, a feedback message in response to the bandwidth part switch command, where the feedback message indicates whether the UE is to accept the switch to the active bandwidth part of the UE to the target bandwidth part in response to the bandwidth part switch command.

By including or configuring the communications manager 720 in accordance with examples as described herein, the device 705 may support techniques for a UE to receive a BWP switch command (e.g., a BWP switch command via a MAC-CE) that indicates a grant in a respective target BWP to support improved communication reliability, reduced latency, improved user experience related to reduced processing, reduced power consumption, more efficient utilization of communication resources, improved coordination between devices, and improved utilization of processing capability.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the at least one processor 740, the at least one memory 730, the code 735, or any combination thereof. For example, the code 735 may include instructions executable by the at least one processor 740 to cause the device 705 to perform various aspects of BWP switching for network devices as described herein, or the at least one processor 740 and the at least one memory 730 may be otherwise configured to, individually or collectively, perform or support such operations.

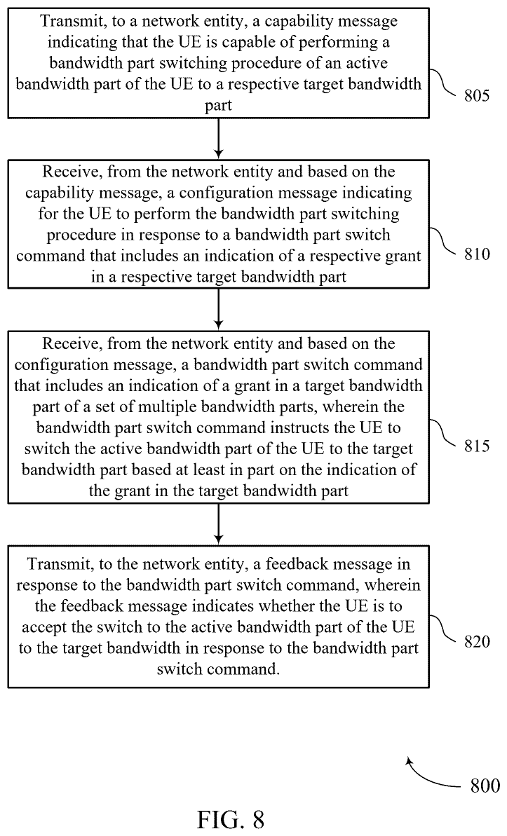

FIG. 8 shows a flowchart illustrating a method 800 that supports BWP switching for network devices in accordance with one or more aspects of the present disclosure. The operations of the method 800 may be implemented by a UE or its components as described herein. For example, the operations of the method 800 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 805, the method may include transmitting, to a network entity, a capability message indicating that the UE is capable of performing a bandwidth part switching procedure of an active bandwidth part of the UE to a respective target bandwidth part. The operations of 805 may be performed in accordance with examples as disclosed herein. In some examples, aspects of the operations of 805 may be performed by a capability message transmitter 625 as described with reference to FIG. 6.

At 810, the method may include receiving, from the network entity and based on the capability message, a configuration message indicating for the UE to perform the bandwidth part switching procedure in response to a bandwidth part switch command that includes an indication of a respective grant in a respective target bandwidth part. The operations of 810 may be performed in accordance with examples as disclosed herein. In some examples, aspects of the operations of 810 may be performed by a configuration message receiver 630 as described with reference to FIG. 6.

At 815, the method may include receiving, from the network entity and based on the configuration message, a bandwidth part switch command that includes an indication of a grant in a target bandwidth part of a set of multiple bandwidth parts, where the bandwidth part switch command instructs the UE to switch the active bandwidth part of the UE to the target bandwidth part based on the indication of the grant in the target bandwidth part. The operations of 815 may be performed in accordance with examples as disclosed herein. In some examples, aspects of the operations of 815 may be performed by a BWP switch command receiver 635 as described with reference to FIG. 6.

At 820, the method may include transmitting, to the network entity, a feedback message in response to the bandwidth part switch command, where the feedback message indicates whether the UE is to accept the switch to the active bandwidth part of the UE to the target bandwidth part in response to the bandwidth part switch command. The operations of 820 may be performed in accordance with examples as disclosed herein. In some examples, aspects of the operations of 820 may be performed by a feedback message transmitter 645 as described with reference to FIG. 6.

The following provides an overview of aspects of the present disclosure:

Aspect 1: A method by a UE, comprising: transmitting, to a network entity, a capability message indicating that the UE is capable of performing a BWP switching procedure of an active BWP of the UE to a respective target BWP; receiving, from the network entity and based at least in part on the capability message, a configuration message indicating for the UE to perform the BWP switching procedure in response to a BWP switch command that comprises an indication of a respective grant in a respective target BWP; receiving, from the network entity and based at least in part on the configuration message, a BWP switch command that comprises an indication of a grant in a target BWP of a plurality of BWPs, wherein the BWP switch command instructs the UE to switch the active BWP of the UE to the target BWP based at least in part on the indication of the grant in the target BWP; and transmitting, to the network entity, a feedback message in response to the BWP switch command, wherein the feedback message indicates whether the UE is to accept the switch to the active BWP of the UE to the target bandwidth part in response to the BWP switch command.

Aspect 2: The method of aspect 1, wherein transmitting the feedback message comprises: transmitting, to the network entity via the feedback message an indication of an acceptance of the BWP switch command or an indication of a denial of the BWP switch command, wherein the indication of whether the UE is to accept the switch the active BWP of the UE to the target BWP in response to the BWP switch command is based at least in part on the indication of the acceptance or the indication of the denial, and wherein the feedback message comprises an indication of a different target BWP.

Aspect 3: The method of any of aspects 1 through 2, further comprising: generating a prediction of subsequent communication traffic, wherein the feedback message is transmitted based at least in part on the prediction of the subsequent communication traffic.

Aspect 4: The method of aspect 3, wherein the prediction of the subsequent communication traffic is generated via an AI/ML model at the UE.

Aspect 5: The method of any of aspects 1 through 4, wherein transmitting the feedback message comprises: transmitting, to the network entity via the feedback message, an acknowledgment of the BWP switch command, a negative acknowledgment of the BWP switch command, a suggestion for the UE to perform the BWP switching procedure from the active BWP to a second target BWP of the plurality of BWPs, or any combination thereof, wherein the second target BWP is different from both the active BWP and the target BWP, and wherein the active BWP, the target BWP, the second target BWP, or any combination thereof have a same downlink control channel monitoring pattern, a different downlink control channel monitoring pattern, or both.

Aspect 6: The method of any of aspects 1 through 5, wherein transmitting the feedback message comprises: transmitting, to the network entity, a negative acknowledgment via the feedback message, wherein the UE refrains from performing the BWP switching procedure from the active BWP to the target BWP based at least in part on the feedback message indicating the negative acknowledgment.

Aspect 7: The method of any of aspects 1 through 6, further comprising: performing, in response to receiving the BWP switch command, the BWP switching procedure from the active BWP to the target BWP.

Aspect 8: The method of any of aspects 1 through 7, further comprising: communicating with the network entity in target BWP in response to a performance of the switch from the active BWP to the target BWP based at least in part on the indication of the grant in the target BWP indicated via in the BWP switch command.

Aspect 9: The method of any of aspects 1 through 8, further comprising: receiving, via the BWP switch command, an indication of a target BWP, a quantity of slots for a BWP switching latency corresponding to a performance of the BWP switching procedure, an uplink grant in the target BWP, a downlink grant in the target BWP, or any combination thereof.

Aspect 10: The method of any of aspects 1 through 9, further comprising: receiving, via the BWP switch command, an indication of a target BWP, a quantity of slots for an uplink grant in the target BWP, a quantity of slots for a downlink grant in the target BWP, or any combination thereof, wherein the BWP switch command indicates a grant size, a quantity of bits, or both, that match the target BWP.

Aspect 11: The method of any of aspects 1 through 10, further comprising: receiving, via the BWP switch command, an indication to switch from a first downlink control channel monitoring pattern to a second downlink control channel monitoring pattern within a same BWP or a different BWP based at least in part on the BWP switch command comprising a BWP identifier that is common or different between the first BWP and the second BWP, wherein the first downlink control channel monitoring pattern and the second downlink control channel monitoring pattern indicate a dense monitoring pattern or a sparse monitoring pattern.

Aspect 12: The method of aspect 11, wherein the one or more network conditions comprise a throughput level satisfying a throughput threshold, a buffer size satisfying a buffer size threshold, a buffer empty latency satisfying a latency threshold, or any combination thereof.

Aspect 13: The UE of any of aspects 1 through 12, wherein the BWP switch command is received based at least in part on one or more network conditions being satisfied.

Aspect 14: The method of any of aspects 1 through 13, wherein the BWP switch command is received via a MAC-CE message.

Aspect 15: A UE comprising a processing system that includes processor circuitry and memory circuitry that stores code, the processing system configured to cause the UE to perform a method of any of aspects 1 through 14.

Aspect 16: A UE comprising at least one means for performing a method of any of aspects 1 through 14.

Aspect 17: A non-transitory computer-readable medium storing code the code comprising instructions executable by one or more processors to perform a method of any of aspects 1 through 14.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
transmit, to a network entity, a capability message indicating that the UE is capable of performing a bandwidth part switching procedure of an active bandwidth part of the UE to a respective target bandwidth part;
receive, from the network entity and based at least in part on the capability message, a configuration message indicating for the UE to perform the bandwidth part switching procedure in response to a bandwidth part switch command that comprises an indication of a respective grant in a respective target bandwidth part;
receive, from the network entity and based at least in part on the configuration message, a bandwidth part switch command that comprises an indication of a grant in a target bandwidth part of a plurality of bandwidth parts, wherein the bandwidth part switch command instructs the UE to switch the active bandwidth part of the UE to the target bandwidth part based at least in part on the indication of the grant in the target bandwidth part; and
transmit, to the network entity, a feedback message in response to the bandwidth part switch command, wherein the feedback message indicates whether the UE is to accept the switch to the active bandwidth part of the UE to the target bandwidth part in response to the bandwidth part switch command.

2. The UE of claim 1, wherein, to transmit the feedback message, the one or more processors are individually or collectively operable to execute the code to cause the UE to:
transmit, to the network entity via the feedback message an indication of an acceptance of the bandwidth part switch command or an indication of a denial of the bandwidth part switch command, wherein the indication of whether the UE is to accept the switch the active bandwidth part of the UE to the target bandwidth part in response to the bandwidth part switch command is based at least in part on the indication of the acceptance or the indication of the denial, and wherein the feedback message comprises an indication of a different target bandwidth part.

3. The UE of claim 1, wherein the one or more processors are individually or collectively further operable to execute the code to cause the UE to:
generate a prediction of subsequent communication traffic, wherein the feedback message is transmitted based at least in part on the prediction of the subsequent communication traffic.

4. The UE of claim 3, wherein the prediction of the subsequent communication traffic is generated via an artificial intelligence or machine learning (AI/ML) model at the UE.

5. The UE of claim 1, wherein, to transmit the feedback message, the one or more processors are individually or collectively operable to execute the code to cause the UE to:
transmit, to the network entity via the feedback message, an acknowledgment of the bandwidth part switch command, a negative acknowledgment of the bandwidth part switch command, a suggestion for the UE to perform the bandwidth part switching procedure from the active bandwidth part to a second target bandwidth part of the plurality of bandwidth parts, or any combination thereof, wherein the second target bandwidth part is different from both the active bandwidth part and the target bandwidth part, and wherein the active bandwidth part, the target bandwidth part, the second target bandwidth part, or any combination thereof have a same downlink control channel monitoring pattern, a different downlink control channel monitoring pattern, or both.

6. The UE of claim 1, wherein, to transmit the feedback message, the one or more processors are individually or collectively operable to execute the code to cause the UE to:
transmit, to the network entity, a negative acknowledgment via the feedback message, wherein the UE refrains from performing the bandwidth part switching procedure from the active bandwidth part to the target bandwidth part based at least in part on the feedback message indicating the negative acknowledgment.

7. The UE of claim 1, wherein the one or more processors are individually or collectively further operable to execute the code to cause the UE to:
perform, in response to receiving the bandwidth part switch command, the bandwidth part switching procedure from the active bandwidth part to the target bandwidth part.

8. The UE of claim 1, wherein the one or more processors are individually or collectively further operable to execute the code to cause the UE to:
communicate with the network entity in the target bandwidth part in response to a performance of the switch from the active bandwidth part to the target bandwidth part based at least in part on the indication of the grant in the target bandwidth part indicated via in the bandwidth part switch command.

9. The UE of claim 1, wherein the one or more processors are individually or collectively further operable to execute the code to cause the UE to:
receive, via the bandwidth part switch command, an indication of the target bandwidth part, a quantity of slots for a bandwidth part switching latency corresponding to a performance of the bandwidth part switching procedure, an uplink grant in the target bandwidth part, a downlink grant in the target bandwidth part, or any combination thereof.

10. The UE of claim 1, wherein the one or more processors are individually or collectively further operable to execute the code to cause the UE to:
receive, via the bandwidth part switch command, an indication of the target bandwidth part, a quantity of slots for an uplink grant in the target bandwidth part, a quantity of slots for a downlink grant in the target bandwidth part, or any combination thereof, wherein the bandwidth part switch command indicates a grant size, a quantity of bits, or both, that match the target bandwidth part.

11. The UE of claim 1, wherein the one or more processors are individually or collectively further operable to execute the code to cause the UE to:
receive, via the bandwidth part switch command, an indication to switch from a first downlink control channel monitoring pattern to a second downlink control channel monitoring pattern within a same bandwidth part or a different bandwidth part based at least in part on the bandwidth part switch command comprising a bandwidth part identifier that is common or different between the active bandwidth part and the target bandwidth part, wherein the first downlink control channel monitoring pattern and the second downlink control channel monitoring pattern indicate a dense monitoring pattern or a sparse monitoring pattern.

12. The UE of claim 1, wherein:
the bandwidth part switch command is received based at least in part on one or more network conditions being satisfied.

13. The UE of claim 12, wherein the one or more network conditions comprise a throughput level satisfying a throughput threshold, a buffer size satisfying a buffer size threshold, a buffer empty latency satisfying a latency threshold, or any combination thereof.

14. The UE of claim 1, wherein the bandwidth part switch command is received via a medium access control (MAC)-control element (CE) message.

15. A method for wireless communications by a user equipment (UE), comprising:
transmitting, to a network entity, a capability message indicating that the UE is capable of performing a bandwidth part switching procedure of an active bandwidth part of the UE to a respective target bandwidth part;
receiving, from the network entity and based at least in part on the capability message, a configuration message indicating for the UE to perform the bandwidth part switching procedure in response to a bandwidth part switch command that comprises an indication of a respective grant in a respective target bandwidth part;
receiving, from the network entity and based at least in part on the configuration message, a bandwidth part switch command that comprises an indication of a grant in a target bandwidth part of a plurality of bandwidth parts, wherein the bandwidth part switch command instructs the UE to switch the active bandwidth part of the UE to the target bandwidth part based at least in part on the indication of the grant in the target bandwidth part; and
transmitting, to the network entity, a feedback message in response to the bandwidth part switch command, wherein the feedback message indicates whether the UE is to accept the switch to the active bandwidth part of the UE to the target bandwidth part in response to the bandwidth part switch command.

16. The method of claim 15, wherein transmitting transmit the feedback message comprises:
transmitting, to the network entity via the feedback message an indication of an acceptance of the bandwidth part switch command or an indication of a denial of the bandwidth part switch command, wherein the indication of whether the UE is to accept the switch the active bandwidth part of the UE to the target bandwidth part in response to the bandwidth part switch command is based at least in part on the indication of the acceptance or the indication of the denial, and wherein the feedback message comprises an indication of a different target bandwidth part.

17. The method of claim 15, further comprising:
generating a prediction of subsequent communication traffic, wherein the feedback message is transmitted based at least in part on the prediction of the subsequent communication traffic.

18. The method of claim 15, wherein transmitting the feedback message comprises:
transmitting, to the network entity via the feedback message, an acknowledgment of the bandwidth part switch command, a negative acknowledgment of the bandwidth part switch command, a suggestion for the UE to perform the bandwidth part switching procedure from the active bandwidth part to a second target bandwidth part of the plurality of bandwidth parts, or any combination thereof, wherein the second target bandwidth part is different from both the active bandwidth part and the target bandwidth part, and wherein the active bandwidth part, the target bandwidth part, the second target bandwidth part, or any combination thereof have a same downlink control channel monitoring pattern, a different downlink control channel monitoring pattern, or both.

19. A non-transitory computer-readable medium storing code for wireless communications, the code comprising instructions executable by one or more processors to:
transmit, to a network entity, a capability message indicating that a user equipment (UE) is capable of performing a bandwidth part switching procedure of an active bandwidth part of the UE to a respective target bandwidth part;
receive, from the network entity and based at least in part on the capability message, a configuration message indicating for the UE to perform the bandwidth part switching procedure in response to a bandwidth part switch command that comprises an indication of a respective grant in a respective target bandwidth part;
receive, from the network entity and based at least in part on the configuration message, a bandwidth part switch command that comprises an indication of a grant in a target bandwidth part of a plurality of bandwidth parts, wherein the bandwidth part switch command instructs the UE to switch the active bandwidth part of the UE to the target bandwidth part based at least in part on the indication of the grant in the target bandwidth part; and
transmit, to the network entity, a feedback message in response to the bandwidth part switch command, wherein the feedback message indicates whether the UE is to accept the switch to the active bandwidth part of the UE to the target bandwidth part in response to the bandwidth part switch command.

20. The non-transitory computer-readable medium of claim 19, wherein the instructions to transmit the feedback message are executable by the one or more processors to:
transmit, to the network entity via the feedback message an indication of an acceptance of the bandwidth part switch command or an indication of a denial of the bandwidth part switch command, wherein the indication of whether the UE is to accept the switch the active bandwidth part of the UE to the target bandwidth part in response to the bandwidth part switch command is based at least in part on the indication of the acceptance or the indication of the denial, and wherein the feedback message comprises an indication of a different target bandwidth part.
